(19) United States
(12) Patent Application Publication
(10) Pub. No.: US 2023/0148425 A1
(43) Pub. Date: May 11, 2023

(54) Makeup Machine with Automatically-Controlled Spray Head Movements

(71) Applicant: GloryMakeup Inc., Taipei City (TW)

(72) Inventor: Daniel Ariel Donohue, Miami, FL (US)

(21) Appl. No.: 18/049,837

(22) Filed: Oct. 26, 2022

Related U.S. Application Data
(60) Provisional application No. 63/276,062, filed on Nov. 5, 2021.
(60) Provisional application No. 63/316,179, filed on Mar. 3, 2022.

(51) Int. Cl. A45D 34/04; A45D 44/00; B05B 3/18; B05B 3/12; B05B 12/00; B05B 15/80

(52) U.S. Cl. CPC A45D 34/04; A45D 44/005; B05B 3/18; B05B 3/12; B05B 12/006; B05B 15/80; A45D 2034/005

(57) ABSTRACT

A makeup machine includes a spray head, a main body, an arched track, and vertical support. The spray head has a receptacle to receive a spray cartridge containing a skin spray. The main body houses a controller circuit that controls a position of the spray head with respect to a target of the skin spray. The arched track has a curved shape on a horizontal plane, and the vertical support is attached to the arched track. The controller circuit causes the spray head to slide along the arched track, and adjusts a height of the vertical support to cause the arched track and the spray head to move up and down. The makeup machine also includes a linear track controlled by the controller circuit to adjust a horizontal distance between the spray head and the target.

### CROSS-REFERENCE TO RELATED APPLICATIONS

This application claims the benefit of U.S. Provisional Application No. 63/276,062 filed on Nov. 5, 2021, and U.S. Provisional Application No. 63/316,179 filed on Mar. 3, 2022.

### TECHNICAL FIELD

Embodiments of the invention relate to a makeup machine that automatically moves a spraying device in multiple directions to apply a skin spray on a user.

### BACKGROUND OF THE INVENTION

The global cosmetics market is a billion-dollar industry, and the demand for beauty and skincare products continues to rise. However, the rise in overall spending on cosmetics does not translate into an increase in the makeup skills of an average consumer. Many people do not have the time, resources, and patience to repeatedly practice with makeup. Manual application of makeup may produce results that could be far from expectation and inconsistent from time to time. To an unskilled person, the experience of applying makeup could be frustrating. Not everyone has the time and resources to seek help from a professional every time makeup is desired.

The advance in robotics, artificial intelligence, and control technologies brings about potential opportunities in automating cosmetics applications. For example, it has been shown that a robot can be trained to apply an eyeshadow brush to a person's face. For a makeup machine to be practical to a user, the machine needs to be versatile, compact, easy to use, and safe, among other properties. However, compactness and versatility are sometimes two competing goals. A machine with versatile features can be bulky. On the other hand, a compact machine typically does not have room for machine components to implement all the desired features.

A compact machine such as a handheld sprayer cannot apply cosmetics with precision as it requires manual movements by the user. The precision may be improved by a stationary machine. However, to apply cosmetics to different areas of a user's face, the user may be asked to physically reposition his/her head a number of times (e.g., facing front, facing right, and facing left) so that the machine can reach the user's face from side to side. The repositioning can cause the machine to misalign the different sides of the user's face and produce undesirable results. It is a challenge to design and build makeup machines with moveable parts that are versatile, compact, and suitable for wide-area coverage of cosmetics on a user's face.

### SUMMARY OF THE INVENTION

In one embodiment, an apparatus includes a spray head having a receptacle to receive a spray cartridge containing a skin spray, a main body to house a controller circuit that controls a position of the spray head with respect to a target of the skin spray, an arched track having a curved shape on a horizontal plane, and a vertical support attached to the arched track. The controller circuit causes the spray head to slide along the arched track, and adjusts the height of the vertical support to cause the arched track and the spray head to move up and down.

In another embodiment, an apparatus includes a spray head, a main body, an arched track, at least one vertical support, and a linear track. The spray head has a receptacle to receive a spray cartridge that contains a skin spray. The main body houses a controller circuit that controls a position of the spray head with respect to a target of the skin spray. At least a portion of the main body is located between an arched track and the target. The arched track has a curved shape on a horizontal plane. The controller circuit causes the spray head to slide along the arched track. The at least one vertical support has an adjustable height and is attached to both the right side and the left side of the arched track. The linear track is controlled by the controller circuit to adjust a horizontal distance between the spray head and the target.

Other aspects and features will become apparent to those ordinarily skilled in the art upon review of the following description of specific embodiments in conjunction with the accompanying figures.

### BRIEF DESCRIPTION OF DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates a makeup machine according to one embodiment.

FIG. 2 is an exploded view of the makeup machine of FIG. 1 according to one embodiment.

FIG. 3 illustrates a vertical movement of the arched track and the spray head according to one embodiment.

FIG. 4 illustrates another vertical movement of the arched track and the spray head according to one embodiment.

FIG. 5 is a top view illustrating a radial movement of a spray head according to one embodiment.

FIG. 6A and FIG. 6B are top views illustrating lateral movements of a spray head according to one embodiment.

FIG. 7A and FIG. 7B illustrate rotational movements of a spray cartridge according to one embodiment.

FIG. 8 is a diagram illustrating a machine having circuitry to read machine-readable code on a spray cartridge according to one embodiment.

FIG. 9 is a diagram illustrating a machine having circuitry to read machine-readable code on a spray cartridge according to another embodiment.

FIG. 10 illustrates a makeup machine according to another embodiment.

FIG. 11 illustrates an arched structure in a fully-retracted position according to one embodiment.

FIG. 12 illustrates an arched structure in an extended position according to one embodiment.

FIG. 13 illustrates a lateral movement of a spray head according to one embodiment.

FIG. 14 illustrates another lateral movement of a spray head according to one embodiment.

FIG. 15 illustrates a vertical movement of the arched track and the spray head according to one embodiment.

FIG. 16 illustrates a chin support having a height-adjustable front piece according to one embodiment.

FIG. 17 illustrates a front piece of a chin support lowered to the same height as a back piece according to one embodiment.

FIG. 18 is a block diagram of a makeup machine according to one embodiment.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Disclosed herein is a makeup machine (also referred to as “machine” or “apparatus”) that can automatically apply professionally designed makeup on a user's face. Although the term “makeup” is used herein, it should be understood that the disclosed machine can apply any skin spray products such as cosmetics, skincare products, and medicinal products on a user's skin. Thus, it is understood that “makeup” is a non-limiting example for the use of the disclosed machine that sprays the contents of a spray cartridge on a user's skin. Although the following description focuses primarily on a user's face, the apparatus and method of the present invention can apply to any part of the human body.

The makeup machine applies a skin spray at a target area such as a user's face. The skin sprays, also referred to as spray-on skin products, include cosmetics products, skincare products, pharmaceutical skin products, dermatological products, and the like. In some embodiments, the skin spray may be a liquid, a fluid, or a liquid-like material including liquid solution, fluid mixture, oil, lotion, or any materials of any viscosity that can be sprayed with compressed air. For simplicity of the following description, the term “liquid” may be used to refer to a skin spray.

The makeup machine includes an arched structure that provides an arched track on the top. The arched track has the shape of an arch that lies on a horizontal plane. A spray head is mounted on the arched track and can slide laterally from one end to the other end of the arched track. The arched track is bilaterally symmetric with respect to a horizontal middle line that passes through the middle of the arched track; that is, the left side and the right side of the arched track are symmetric. A target (e.g., a user's head) can be positioned on this horizontal middle line such that the spray released from the spray head can reach both sides of the user's face. In one embodiment, the machine includes a chin support for a user to rest his/her head. The chin support may be positioned on this horizontal middle line and attached to the front section of the machine's main body. In an embodiment where the shape of the arched track is a segment of a circle, the chin support may be positioned off-centered; e.g., the geometric center of the chin support on the horizontal plane does not coincide with the center of the circle. The chin support in such an embodiment may be positioned on the middle line in a direction away from the middle of the arched track (i.e., towards the user). This off-centered position provides space for the spray head's movement and ensures that the user's protruding features (e.g., nose) do not interfere with the spray head's movement.

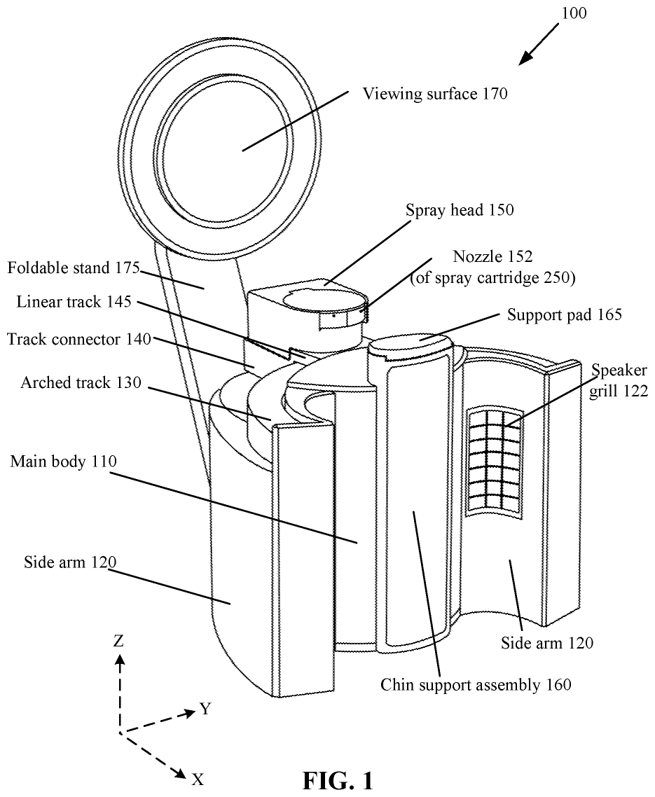

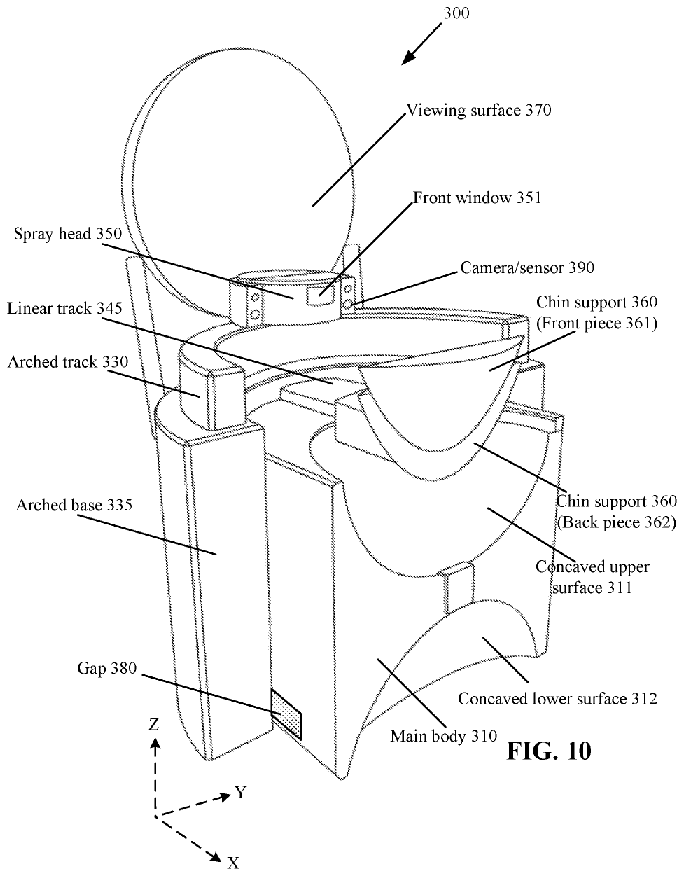

In addition to the side-to-side lateral movement, the spray head can move forwards and backward on the horizontal plane. The spray head can slide backward on a linear track to increase the horizontal distance to the target, or slide forwards on the linear track to decrease the distance. Two embodiments of the linear track will be described with reference to FIG. 1 and FIG. 10. Different kinds of skin sprays may require different distances between the spray head and the user. For example, the spray head may need to be closer to the user's face to highlight the contour of the face, and farther away from the face to apply foundation. With the combination of the arched track and the linear track, the spray head can easily maintain a proper distance from the user's face.

The makeup machine further includes a height adjustment mechanism to adjust the height of the spray head relative to the user's face. In one embodiment, the height adjustment mechanism includes one or more vertical pillars attached to the arched track to move the arched track and the spray head thereon in the vertical direction. For example, the arched track may be supported by pillars that can extend and retract vertically to move the arched track up and down. The pillars enable the spray head to reach the entire vertical range of a user's face, from the top of the forehead (when the pillars are fully extended) to the chin (when the pillars are fully retracted). In another embodiment, the height adjustment mechanism may include a vertical pole attached to the spray head to move the spray head up and down. Moving the arched track with the spray head thereon improves the stability of the spray head and the precision of the spray during machine operation.

A spray cartridge containing one or more types of skin sprays can be inserted or placed into the spray head and removed after use. The spray cartridge has one or more nozzles on the periphery, and can rotate horizontally around its center axis to aim a nozzle in the direction of the target. As will be described in further detail below, the spray cartridge rotation can increase the angular spray range among other advantages.

The makeup machine can be placed on a tabletop or a countertop with a minimal footprint. The compact size of the machine is benefitted from the combined use of the arched track, the linear track, the retractable/extensible pillars, and the rotatable spray cartridge. With the linear track providing an adjustable horizontal distance between the spray head and the user's face, the sides of the arched track can be made closer to the sides of the face; that is, the radius of the arched track can be minimized. The rotation of the spray cartridge can further reduce the length of the arched track, which is directly proportional to the arch curvature for a fixed radius. To extend the angular range of the spray, the spray cartridge can horizontally rotate around its center axis by a predetermined angular range. Thus, the curvature of the arched track may be reduced to less than 180 degrees and the spray can still reach both sides of the user's face from ear to ear. Furthermore, the pillars that enable the spray head's vertical movement can be retracted into the machine; e.g., a side structure of the machine. The retracted portions of the pillars are hidden away from the user and do not take up space. Thus, the height of the machine can be minimized. The machine structure on which the spray head moves can be so compact that its footprint on a tabletop is similar to that of a laptop computer.

In one embodiment, the main body of the makeup machine houses a controller circuit and motors to drive the movements of the spray head. At least a portion of the main body is located in front of the arched track, between the arched track and the user. As used herein, the term “front” refers to the user-facing side and the term “back” refers to the side away from the user. The compact size of the machine is further benefitted from the position of the main body.

As will be explained in the following embodiments, the makeup machine is compact, versatile, easy to use, and safe. The spray head has flexibility in movements, full coverage of a user's face, and precision in spray operations. A sufficient distance and a proper angle between the spray head and the user's face can be maintained throughout a makeup process. The user can remain stationary in one position during the machine operation, and the spray head moves along the arched track around the user's face. Thus, the skin spray can be sprayed on the entire face with high precision without the user turning or repositioning his/her head, and without the aforementioned alignment issues caused by the head repositioning.

In the drawings accompanying the following detailed description, a disc of a round shape is shown as an example of a spray cartridge. It is understood that the disclosed makeup machine can use a spray cartridge of another shape not limited to a round shape. Furthermore, the spray head may have a different shape to house a different sized and/or shaped spray cartridge from what is shown in the drawings. The spray cartridge disclosed herein can be used in other machines that can spray atomized liquids on a user's skin, and the makeup machine disclosed herein can use other types of spray cartridges not limited to the ones shown and described in this disclosure.

FIG. 1 illustrates a makeup machine 100 according to one embodiment. The makeup machine 100 includes a main body 110 with two side arms 120. On top of the main body 110 and the side arms 120 lies an arched track 130. The arched track 130 has the shape of an arch that may be a segment of a circle, an ellipse, a curved shape, or a combination of multiple curved shapes. A spray head 150 is mounted on top of the arched track 130; more specifically, the spray head 150 sits on a track connector 140 that connects the spray head 150 to the arched track 130. The top of the track connector 140 is a linear track 145 along which the spray head 150 can slide back and forth to adjust the horizontal distance between the spray head 150 and a user's face. The track connector 140 may house one or more motors to move the spray head 150 across the arched track 130 and/or rotate a spray cartridge 250 inside the spray head 150, and/or move the spray head 150 along the linear track 145.

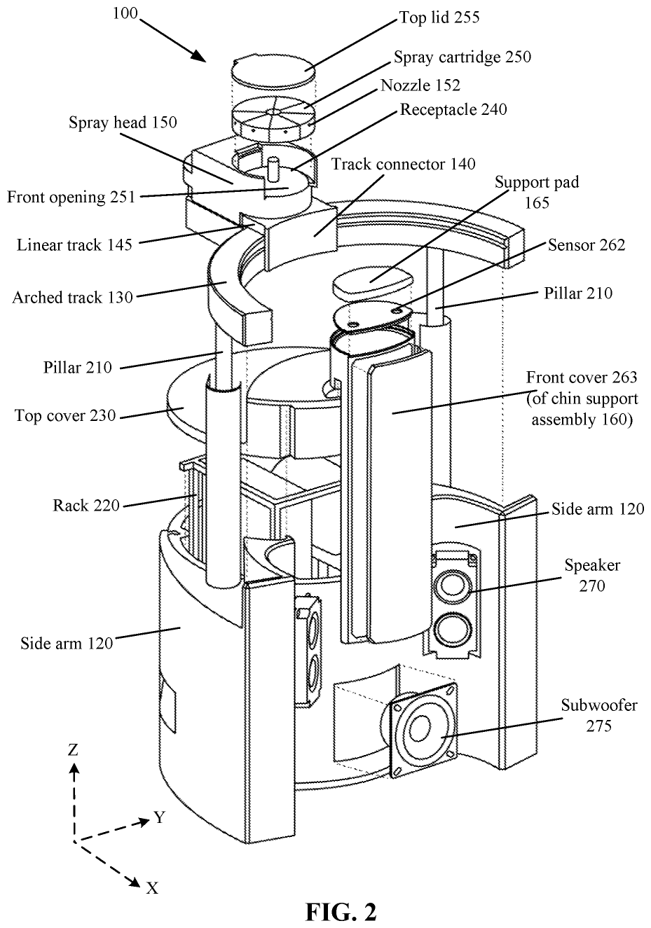

In one embodiment, the spray head 150 has a front opening (e.g., a front opening 251 in FIG. 2) through which the spray cartridge 250 can be seen. The spray cartridge 250 may include multiple nozzles 152 on the periphery. Further details regarding the spray cartridge 250 will be provided below with reference to FIG. 2.

At the front side of the main body 110 is a chin support assembly 160 having an elongated shape in the vertical direction. The top portion of the chin support assembly 160 rests on top of the front section of the main body 110. On the top surface of the chin support assembly 160 is a support pad 165 on which a user's chin may rest. The chin support assembly 160 provides support for a user's chin and helps with positioning the user's head to an optimal usage position (e.g., with respect to depth and height) and posture (for the optimal spraying capability on the skin to avoid wrinkling). In this embodiment, the chin support assembly 160 includes a vertical stand that extends longitudinally along the front side of the main body 110 to reach the surface on which the machine 100 stands (e.g., a tabletop).

The machine 100 may also include a viewing surface 170 such as a mirror or a digital display screen. The viewing surface 170 is supported by a foldable stand 175 that can be folded down on top of the machine 100. The foldable stand 175 is secured to the back side of the main body 110. The viewing surface 170 faces the user's face when the foldable stand 175 is in a deployed position. The viewing surface 170 faces the top of the main body 110 when the foldable stand 175 in a stowed position. In one embodiment, the viewing surface 170 and the foldable stand 175 may be packaged and sold as a separate module from the rest of the machine 100. Further details about the viewing surface 170 are provided after the description of FIG. 17.

The side arms 120 curve towards the user who receives the skin spray. The back wall of the side arms 120 and the back wall of the main body 110 form a curved outer wall of the machine 100. The side arms 120 may include electronic circuitry embedded therein such as speakers, a wireless interface (e.g., Bluetooth, Wi-Fi, etc.), etc. The user-facing (inner) wall of each side arm 120 may include speaker grills 122 to protect the speaker components inside the side arm 120.

FIG. 2 is an exploded view of the makeup machine 100 of FIG. 1 according to one embodiment. To avoid cluttering the drawing, some components shown in FIG. 1 are omitted in FIG. 2. FIG. 2 shows that the machine 100 includes two pillars 210 that extend upwards from the respective side arms 120 to support both the right side and the left side of the arched track 130. The two pillars 210 can extend and retract in tandem to move the arched track 130 up and down. Although two pillars 210 are shown in FIG. 2, in alternative embodiments the machine 100 may include any number of pillars to support the arched track 130. The main body 110 has a top cover 230, which can be opened up to expose an inner cavity in which a rack 220 can be placed. The rack 220 contains circuit boards (which may include one or more processors integrated thereon) for controlling the spray head movement, an air tank for storing compressed air, and motors for operating the machine 100. In one embodiment, the rack 220 can be pre-assembled and placed into the main body 110. The rack 220 may include corner latches to be fastened to the main body 110.

The pillars 210 are housed in the side arms 120. The pillars 210 are hidden inside the side arms 120 when the arched track 130 is lowered to rest on the top of the main body 110. The side arms 120 provide stability to the main body 110 when the track connector 140 (and the spray head 150 thereon) is at the furthest ends of the left or right side of the arched track 130. A number of speakers 270 and a subwoofer 275 may be installed inside the side arms 120 and/or at the front side of the main body 110.

In one embodiment, the main body's top cover 230 has a back section lower in height than a front section. The back section is where the arched track 130 lies in a stowed position. The front section of the top cover 230 has a notch to engage with the chin support assembly 160 such that the chin support assembly 160 can be securely attached to the main body 110.

In one embodiment, the chin support assembly 160 includes one or more sensors 262 under the support pad 165 to detect the user's head movement. A pressure sensor may be installed under the support pad 165 to detect whether or not the user's chin is on the support pad 165 and, as a safety feature, generates a warning signal or stops the machine operation if the user leaves abruptly. In one embodiment, the chin support assembly 160 may integrate a rear-facing camera to capture the spray head position and/or the cartridge color codes through the front opening 251 or a front window of the spray head 150. The rear-facing side (near the top end) of the chin support assembly 160 may include one or more proximity sensors to verify that nothing has fallen into the spray head movement zone for added safety.

This support pad 165 is ergonomically shaped to support the user's chin and to minimize the user's head movement. In one embodiment, the support pad 165 can be removed from the machine 100 and washed or cleaned. A user may purchase a new shape or color of the support pad 165 as an accessory, which can be easily placed into position with a magnet or other attachment means. A user may also remove and replace the front cover of the chin support assembly 160 with one having a different design pattern. In one embodiment, the chin support assembly 160 can also be removed from the machine 100 and washed or cleaned.

FIG. 2 shows the spray cartridge 250 loaded into the receptacle 240 of the spray head 150. The receptacle 240 can be closed by a top lid 255 of the spray head 150. A user may open the top lid 255 to place the spray cartridge 250 into the receptacle 240. In one embodiment, the bottom of the receptacle 240 may be slightly smaller in area size than the spray cartridge 250, such that the spray cartridge's bottom surface near the front side is exposed. To remove the spray cartridge 250 from the spray head 150, a user may open the top lid 255 and lift up the spray cartridge 250 by holding onto both the top and the bottom of the spray cartridge 250 at the front end.

The spray cartridge 250 may include one or more nozzles 152 located on the periphery. Through the front opening 251, one of the nozzles 152 can spray a skin spray on the user's face. Furthermore, the front opening 251 provides a passage to the skin spray when the spray cartridge 250 rotates within a limited range to reach a wider target area. In some scenarios, the limited-range rotation can be used to produce a diffusion effect.

In one embodiment, the spray cartridge 250 includes multiple partitions, and each partition includes a liquid tank for storing a liquid and a nozzle for spraying the liquid stored in the corresponding liquid tank. Different liquid tanks may store different skin spray materials. Some of the nozzles may have different shapes and/or sizes. In another embodiment, the spray cartridge 250 may contain a single liquid tank containing a single liquid material and a single nozzle. In such an embodiment, the spray cartridge 250 may be referred to as a pod. When the machine 100 is in operation, a motor can drive the spray head 150 to rotate the spray cartridge 250, such that a selected nozzle points to the target area of a user.

Although not shown in FIG. 1 and FIG. 2, in some embodiments, the machine 100 may include an under-the-table unit to house components that generate vibrations, noise, or other distracting or undesirable effects. It is understood that the under-the-table unit may be placed on the floor or a low shelf under the table on which the main body 110 is placed. The unit may be connected to the parts above the table via electric cables, air tubes, etc. Examples of the components in the unit may include, but are not limited to: a power supply, a cooling system, an air pump (for generating compressed air), etc. In one embodiment, the subwoofer 275 may be located in this unit instead of the main body 110 for optimal bass sound effects.

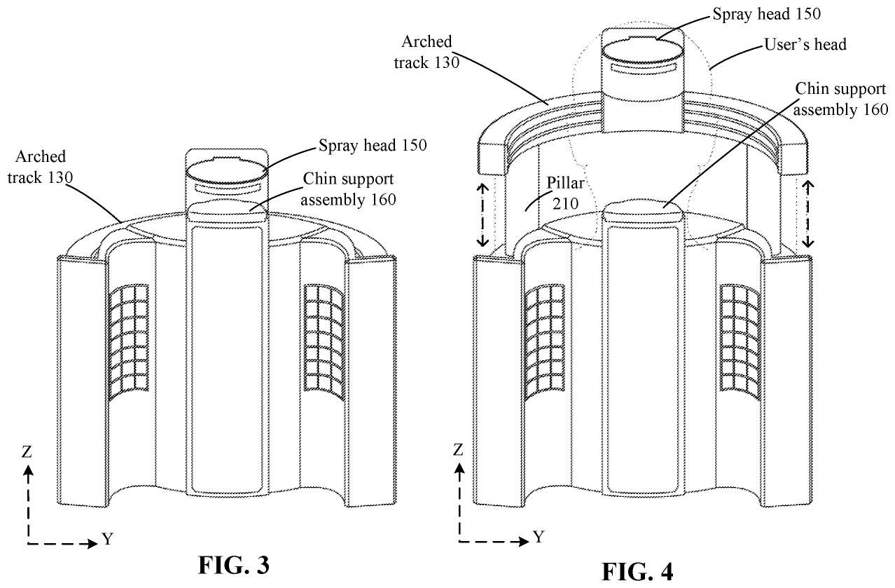

In the following description with reference to FIG. 3-FIG. 9, the viewing surface 170 is omitted to simplify the illustration.

FIG. 3 and FIG. 4 illustrate the vertical movement of the arched track 130 and the spray head 150 according to one embodiment. The pillars 210 serve as a height adjustment mechanism that extends and contracts to adjust the height of the arched track 130 and the spray head 150 on the arched track 130. Although two pillars are shown, it is understood that the machine 100 may include other forms of vertical supports to adjust the height of the arched track 130 and the spray head 150 thereon. In one embodiment, the vertical support is attached to the bottom of both the right and left sides of the arched track 130 to provide stability when the spray head 150 moves to either end of the arched track 130. The terms “right side” and “left side” herein refer to any points on the arched track 130 to the right and to the left of the middle point of the arched track 130, respectively. Examples of vertical support may include, but are not limited to: one or more of the pillars 210, one or more telescopic poles, a vertical wall, stand, or panel that extends from the right side to the left side of the arched track 130, etc. It is understood that the vertical support for the arched track 130, regardless of its form, can be extended and retracted as shown in the examples of FIG. 3 and FIG. 4. In one embodiment, the vertical support, regardless of its form, when retracted can be hidden away inside the machine 100 or a structure attached to the machine 100. In FIG. 3, the arched track 130 is in the stowed position. In FIG. 4, the pillars 210 are extended upwards to move the arched track 130 and the spray head 150 to a higher position. In one embodiment, the two pillars 210 are driven by a motor to extend and retract in tandem, which causes the arched track 130 to move up and down. In one embodiment, the two pillars may be connected together by a belt or rod at or near the bottom end to ensure their tandem movements. In one embodiment, each pillar 210 may be driven by a screw-type linear motor to produce the vertical movement.

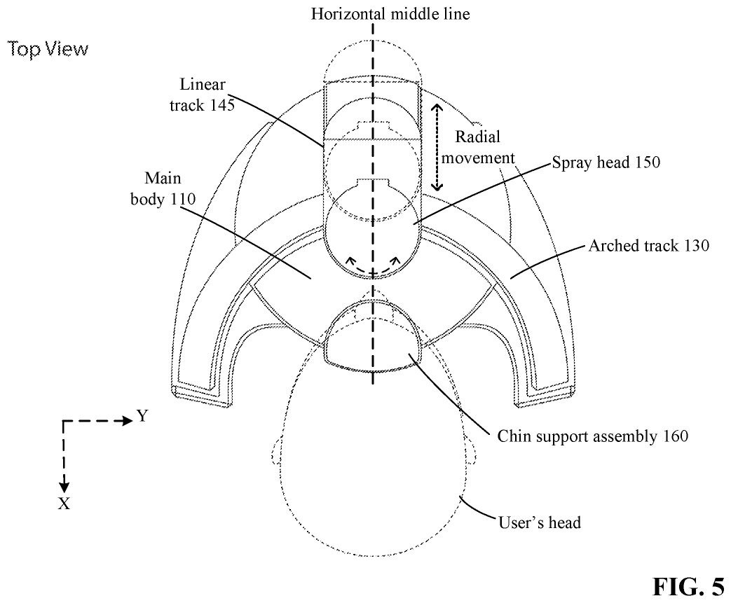

FIG. 5 is a top view illustrating a radial movement of the spray head 150 on the linear track 145 according to one embodiment. The radial movement of the spray head 150 on the linear track 145 is indicated by the dashed outlines of the spray head 150. This movement adjusts the horizontal distance between the spray head 150 and the user's face. The spray head 150 can slide along the linear track 145 backward and forwards with respect to the user's head, and the linear track 145 can move with the spray head 150 from one end to the other end of the arched track 130. The spray head 150 can slide along the linear track 145 when the linear track is at any given position on the arched track 130. The longitudinal direction of the linear track 145 is perpendicular to the tangential line of the arched track 130; thus, the longitudinal direction of the linear track 145 defines the direction of the radial movement of the spray head 150.

FIG. 5 also indicates that the spray head 150 may rotate the spray cartridge 250 inside clockwise and counterclockwise to adjust the aim of the spray with respect to the user's face. The rotational movement during the spraying operation can increase the angular spray range. The spray from the spray cartridge 250 can pass through the front opening 251 (FIG. 2) at the front side of the spray head 150. In an embodiment where the spray cartridge 250 has multiple nozzles on the periphery, the spray head 150 may rotate the spray cartridge 250 to select different nozzles for spraying.

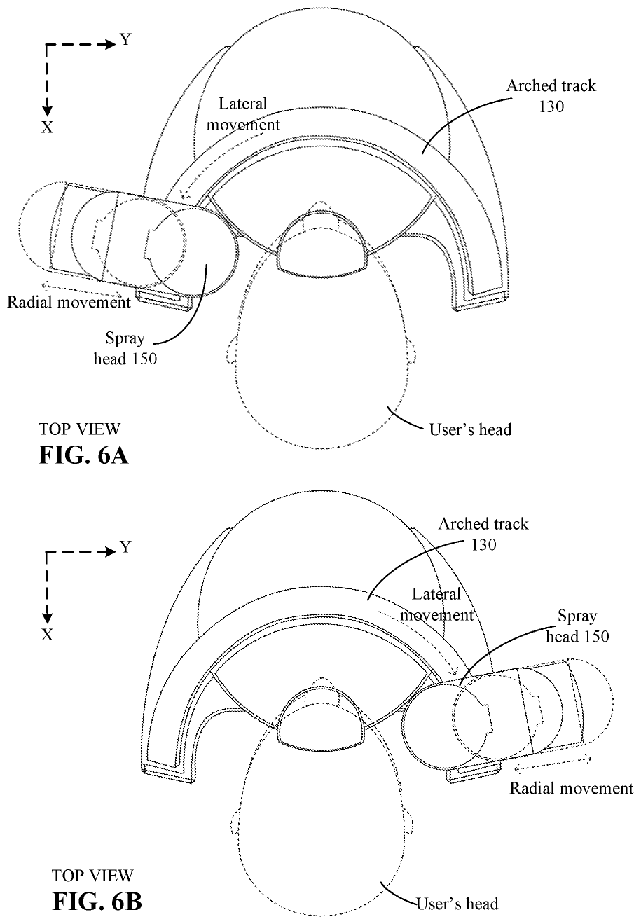

FIG. 6A and FIG. 6B are top views illustrating lateral movements of the spray head 150 on the arched track 130 according to one embodiment. Some of the previously-labeled machine elements are not labeled again in these figures to avoid clustering. FIG. 6A shows the spray head 150 moving to the left end of the arched track 130, and FIG. 6B shows the spray head 150 moving to the right end of the arched track 130. Moreover, FIG. 6A and FIG. 6B also show the radial movement of the spray head 150 (indicated by the dashed outlines of the spray head 150). Referring also to FIG. 1 and FIG. 2, the spray head 150 is mounted on top of the track connector 140 and can slide with the track connector 140 along the arched track 130 in a lateral movement. The spray head 150 can move along the arched track 130 to follow the face contour and to get full coverage of the user's face.

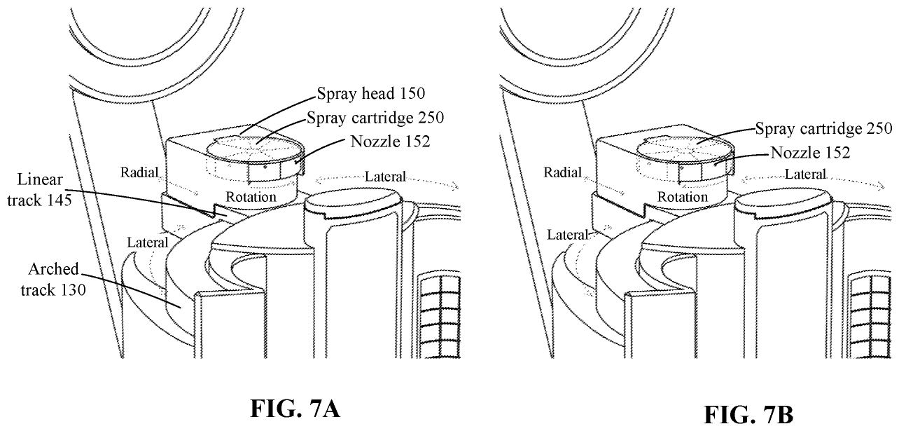

FIG. 7A and FIG. 7B illustrate the rotational movements of the spray cartridge 250 according to one embodiment. Some of the previously-labeled machine elements are not labeled again in these figures to avoid clustering. FIG. 7A shows the spray cartridge 250 rotating counter-clockwise, and FIG. 7B shows spray cartridge 250 rotating clockwise. As previously mentioned, the spray cartridge rotation can increase the angular spray range over a target area. Furthermore, the rotation allows a different nozzle 152 of the spray cartridge 250 to be selected for spraying. Moreover, FIG. 7A and FIG. 7B also show arrows indicating the radial movement of the spray head 150 along the linear track 145 and the lateral movement along the arched track 130.

In one embodiment, a machine-readable code (e.g., a barcode, a QR code, a radio-frequency identifier (RFID), etc.) may be printed on the outer surface of the spray cartridge 250 (FIG. 2). The code identifies the type or the color of the liquid stored in the spray cartridge 250. The code can also be used for validation or security purposes; e.g., to prevent counterfeiting, or for warning purposes; e.g., to warn the user of the expiration of the liquid.

In an embodiment, the spray cartridge 250 is modularized. That is, the spray cartridge 250 is assembled by multiple individual partitions and any partition can be removed from the cartridge and replaced by another partition. Each partition may have a machine-readable code (e.g., a barcode, a QR code, an RFID, etc.) printed on the surface to identify the type or the color of the liquid stored in that partition. The machine 100 can check the code on each partition to determine and inform the user whether he/she assembles the correct partitions into the modularized spray cartridge (e.g., for a makeup template selected by the user). The code on each partition can also be used for validation or security purposes; e.g., to prevent counterfeiting in any of the partitions, or for warning purposes; e.g., to warn the user of the expiration of the liquid in any of the partitions.

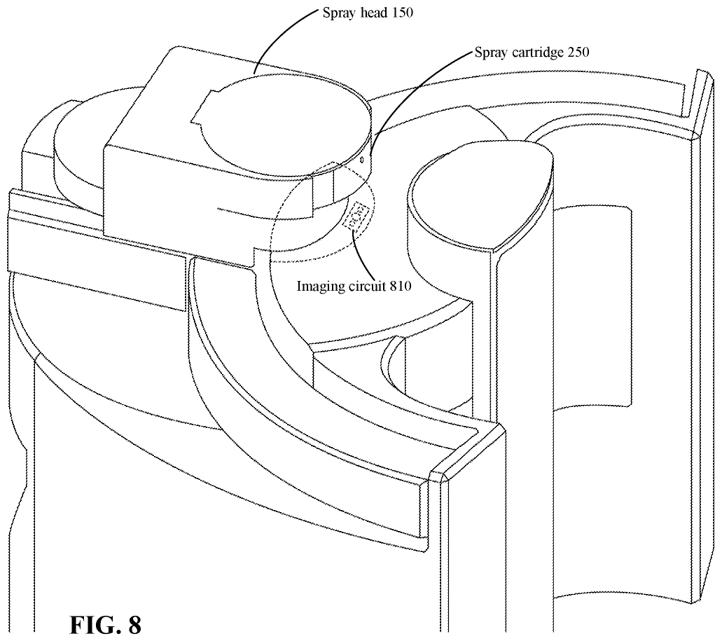

FIG. 8 is a diagram illustrating the machine 100 having circuitry to read machine-readable code on the spray cartridge 250 according to one embodiment. Referring also to FIG. 2, the main body 110 has the top cover 230 with a raised front section in front of the arched track 130. Also, as mentioned before with reference to FIG. 2, the front bottom surface of the spray cartridge 250 is exposed through the front opening 251 of the spray head 150. The exposed surface of the spray cartridge 250 may have machine-readable code printed thereon. When the spray head 150 moves forward (e.g., towards the user's face) on the linear track 145, the exposed surface of the spray cartridge 250 overlaps with the front section of the top cover 230. In one embodiment, this overlapped portion includes an upward-facing imaging circuit 810 (e.g., camera, scanner, etc.) to read the machine-readable code printed on the spray cartridge 250. In an alternative embodiment, the bottom surface of the spray head 150 has a bottom window through which the machine-readable code printed on the bottom of the spray cartridge 250 is exposed. The imaging circuit 810 reads the machine-readable code for identification including but not limited to the aforementioned verification, validation, security, and warning purposes. In an embodiment where the spray cartridge 250 is modularized, each partition of the spray cartridge 250 may have the machine-readable code printed on the bottom surface. The spray cartridge 250 may be rotated such that the imaging circuit 810 can read the code on each partition of the spray cartridge 250; e.g., one partition at a time.

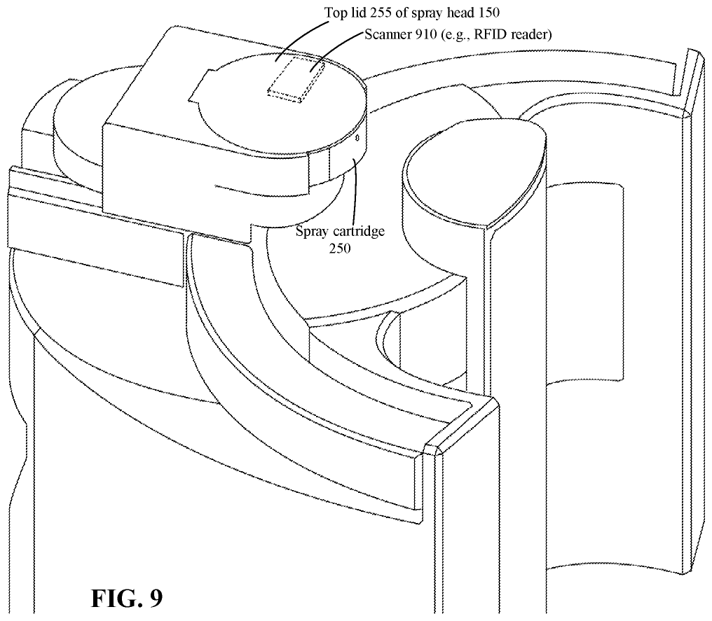

FIG. 9 is a diagram illustrating the machine 100 having circuitry to read machine-readable code on the spray cartridge 250 according to another embodiment. In this embodiment, the circuitry is a scanner 910 integrated into the top lid 255 of the spray head 150. The scanner 910 may be positioned at a position corresponding to the code printed on the spray cartridge 250. In an embodiment where the spray cartridge 250 is modularized, each partition of the spray cartridge 250 may have the machine-readable code printed on the surface where the scanner 910 can read. The spray cartridge 250 may be rotated such that the scanner 910 can read the code on each partition one at a time. In an embodiment where the scanner 910 is an RFID reader, the machine-readable code is an RFID embedded in the spray cartridge 250. The RFID reader may be positioned anywhere in the machine 100, such as the main body 110, the side arms 120, inside the spray head 150, or on the surface of the machine 100, as an RFID can be read without a line of sight.

FIG. 10 illustrates a makeup machine 300 according to another embodiment. In this embodiment, the machine 300 includes an arched structure, which further includes an arched track 330 on top of an arched base 335. A spray head 350 is mounted on top of the arched track 330. The spray head 350 moves along the arched track 330 to follow the contour of a target area such as a user's face. The spray head 350 has a front window 351 for a skin spray to pass through.

The spray head 350 includes a receptacle to receive a spray cartridge, such as the spray cartridge 250 in FIG. 2. In the example of FIG. 10, the top lid of the spray head may be opened to receive a spray cartridge. In another embodiment, a spray cartridge may be inserted into a slot on a side of the spray head 350. The front window 351 of the spray head 350 opens up to a nozzle of the spray cartridge. In one embodiment, the spray head 350 may rotate the spray cartridge to adjust the nozzle position in the front window 351 in order to fine-tune the aim of the spray. In an embodiment where the spray cartridge has multiple nozzles on the periphery, the spray head 350 may rotate the spray cartridge to select different nozzles for spraying.

The machine 300 includes a main body 310 that provides a housing for control circuitry, motors, and in some embodiments, the air supply for the operation of the spray head 350. In this example, the front side of the main body 310 has a concaved upper surface 311 and a concaved lower surface 312. However, it is understood that the main body 310 may have a different shape than what is shown.

The machine 300 includes a linear track 345 that rests on top of the main body 310. Similar to the machine 100 (FIG. 1), the linear track 345 is used to adjust the horizontal distance between the spray head 350 and the user's face. Different from the machine 100, the spray head 350 is not mounted on the linear track 345, and the linear track 345 does not move with the spray head 350. The linear track 345 stays on the horizontal centerline of the arched structure during machine operation. The length of the linear track 345 is adjustable by the control circuitry to position the spray head 350 at a given horizontal distance from the target (e.g., the user's face). The linear track 345 extends to move the arched structure farther away (i.e., in the distal direction), and retracts to move the arched structure closer to the user (i.e., in the proximal direction), where the arched structure includes both the arched track 330 and the arched base 335. The movement of the linear track 345 may be driven by a motor in the main body 310.

In one embodiment, the proximal end of the linear track 345 connects to a back piece 362 of a chin support 360, and the distal end is connected to the arched base 335. As the arched base 335 and the arched track 330 move in tandem and the spray head 350 is mounted on the arched track 330, the linear track movement enables a proximal-distal movement of the spray head 350. The machine 300 can use this proximal-distal movement to adjust the horizontal distance between the spray head 350 and the user's face.

The linear track 345 may provide a passage for electric cables that connects control circuitry or motors to adjust the position of the spray head 350 and spray cartridge. In one embodiment, the linear track 345 may also provide a passage for an air tube to deliver compressed air from an air source such as an air tank or air pump to the spray cartridge.

In one embodiment, the chin support 360 includes the back piece 362 and a front piece 361. The back piece 362 is stationary when the linear track 345 extends and retracts. The front piece 361 is where the user's chin rests. The front piece 361 is up-and-down adjustable; e.g., the front piece 361 may be raised to position the user's chin at an appropriate height with respect to the spray head 350.

FIG. 10 also shows a gap 380 near the bottom edge of the main body 310. The gap 380 allows a belt or rod to connect the left side and the right side of the arched base 335, such that both sides can synchronize the vertical movement of the arched track 330. The vertical movement will be described later with reference to FIG. 16. The belt or rod moves together with the arched base 335. The arched base 335 may contain two motors at both the right and left sides (or one stepper motor at one side and one actuator at the other side) to drive the vertical movement.

FIG. 10 also shows cameras and/or sensors 390 on the front side of the spray head 350 to capture a 3D image of the user. In one embodiment, a curved light may be disposed along the front-facing surface of the arched track 330 to light the user's face (e.g., for taking pictures and for other actions). In one embodiment, lights may be disposed on the concaved upper surface 311 of the main body 310 under the chin support 360. Although not shown in FIG. 10, speakers can be disposed on the inner sides (both left and right) of the arch base 335 or other parts of the machine 300 for optimal acoustics. A wireless interface (e.g., Bluetooth, Wi-Fi, etc.) may also be provided to connect the machine 300 and/or the speakers to a network or a user's mobile phone. Although not shown in FIG. 1-FIG. 9, it is understood that machine 100 may also have cameras and/or sensors on the front side of the spray head 150, the light on the front-facing surface of the arched track 130, and the light on the upper surface of the main body 110.

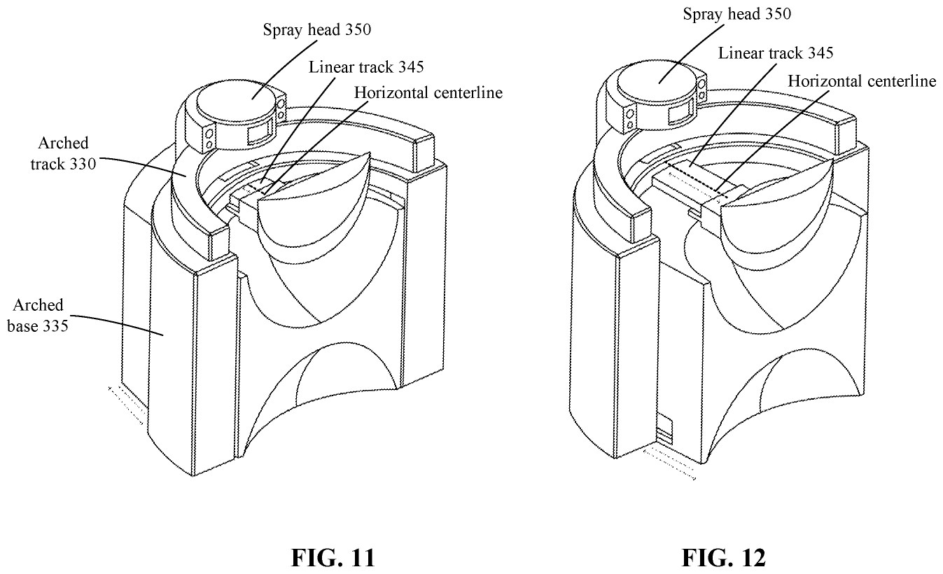

The machine 300 also provides a viewing surface 370 similar to the viewing surface 170 in FIG. 1. In the following description with reference to FIG. 11-FIG. 17, the viewing surface 370 is omitted to simplify the illustration.

The linear track 345 stays on a horizontal centerline and has a horizontal length adjustable by the controller circuit to position the spray head at a given horizontal distance from the target. FIG. 11 illustrates the arched structure in a fully-retracted position according to one embodiment. The linear track 345 is retracted in the proximal direction to move the arched structure and the spray head 350 thereon towards the user. In this position, the front edge of the arched base 335 may be flush with the front side of the main body 310. FIG. 12 illustrates the arched structure in an extended position according to one embodiment. The linear track 345 is extended in the distal direction to move the arched structure and the spray head 350 thereon away from the user. In one embodiment, the machine 300 includes a motor under the arched track 330 behind the chin support 360 to drive the extension and retraction of the linear track 345.

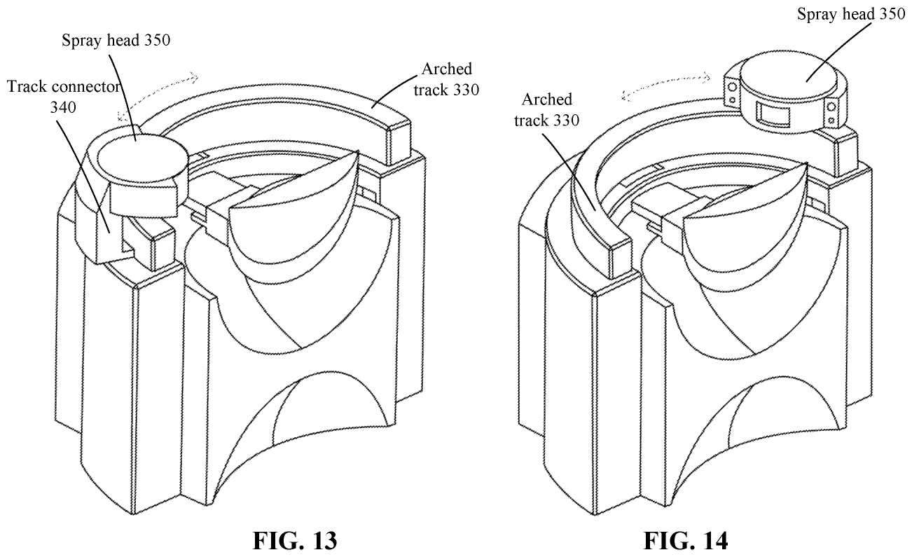

FIG. 13 and FIG. 14 illustrate lateral movements of the spray head 350 on the arched track 330 according to one embodiment. Some of the previously-labeled machine elements are not labeled again in these figures to avoid clustering. FIG. 13 shows the spray head 350 moving towards the left end of the arched track 330, and FIG. 14 shows the spray head 350 moving towards the right end of the arched track 330. The spray head 350 sits on a track connector 340 that connects the spray head 350 to the arched track 330. The track connector 340 may house one or more motors to move the spray head 350 across the arched track 330 and/or rotate the spray cartridge inside the spray head 350.

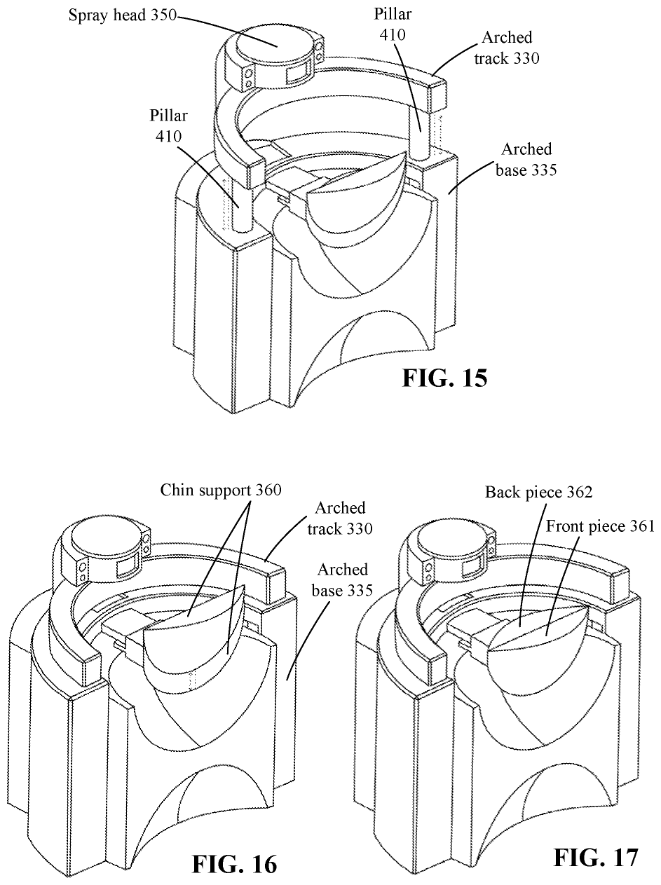

FIG. 15 illustrates the vertical movement (e.g., upwards) of the arched track 330 and the spray head 350 according to one embodiment. In one embodiment, the arched track 330 is supported by two side pillars 410 that extend from the arched base 335. The pillars 410 can extend upwards from the arched base 335 to cover the full head height. The two pillars 410 can go up and down in the vertical direction synchronously, due to the belt or rod in the gap 380 (FIG. 10) that connects the two pillars 410. In this example, the pillars 410 are attached to the bottom of both the right and the left sides of the arched track 330 to provide stability. When the pillars 410 retract to lower the arched track 330, the retracted portions of the pillars 410 are hidden away from the user (e.g., inside the arched base 335) and do not take up space. It is understood that the pillars 410 is an example of the vertical support for adjusting the height of the arched track 330 and the spray head 350, alternative embodiments of the vertical support have been described in connection with the pillars 210 of FIG. 4.

FIG. 16 illustrates the arched track 330 lowered to lie on top of the arched base 335 according to one embodiment. FIG. 16 and FIG. 17 also illustrate that the front piece 361 of the chin support 360 has an adjustable height (as indicated by a dotted double-side arrow in FIG. 16). In FIG. 10-FIG. 16, the front piece 361 of the chin support 360 is in a raised position. FIG. 17 illustrates the front piece 361 lowered to the same height as the back piece 362. As mentioned before, the height of the front piece 361 is up-and-down adjustable; e.g., the front piece 361 can be raised to position the user's chin at an appropriate height with respect to the spray head 350. The front piece 361 may have embedded sensors to detect whether or not the user's chin is on the chin support 360 and, as a safety feature, allow the machine operation to be stopped if the user leaves abruptly.

The above description provides two non-limiting examples of a makeup machine; i.e. the machine 100 (FIG. 1-FIG. 9) and the machine 300 (FIG. 10-FIG. 17). It is understood the scope of this disclosure encompasses makeup machines having various dimensions, shapes, and/or sizes. The following description provides further details on features that are common to the machines 100 and 300. Please refer to FIG. 1-FIG. 17 for numerals that label the corresponding components of each machine.

In one embodiment, the machine (100 or 300) includes a component with a viewing surface (170 in FIG. 1 or 370 in FIG. 10). In one embodiment, the viewing surface may be a mirror that shows a reflection of the user; the mirror may be a plane mirror or a magnifying mirror. In another embodiment, the viewing surface may be provided by a digital display panel (e.g., a computer and/or smartphone display screen such as a liquid crystal display (LCD) display or a display based on another technology) that displays a digital image. In yet another embodiment, the viewing surface may include a combination of a mirror and a digital display panel. The digital image may be a digital image of the user, an augmented reality (AR) digital image (e.g., a makeup or styling choice superimposed on the user's image), an image or image sequence (e.g., a video) recommended for or selected by the user, a real-time online consulting session with a makeup coach or another party of interest to guide the user in the makeup process, a website such as a social media site, and the like. The viewing surface, or an outer rim of the viewing surface, may include cameras, sensors, microphones, speakers, lighting, and/or control buttons. In one embodiment, the viewing surface contains lighting that can change according to the user's input, or automatically according to the sensor input; e.g., the sensors embedded in the viewing surface or elsewhere on the machine. The viewing surface may also include a software interface embedded in the viewing surface to help the user to navigate the many functions of the machine. The viewing surface is attached to the machine via an attaching means; e.g., two foldable arms or the foldable stand.

In one embodiment, the main body (110 or 310) of the machine (100 or 300) includes an inner cavity to store electrical, mechanical, and/or electronics components including but not limited to one or more of: a motor, a battery, an air compressor, electrical wires, communication electronics to provide wireless connectivity (e.g., Bluetooth, Wi-Fi, and the like), one or more processors, and a memory module. In some embodiments, some of the components (e.g., the air compressor) may be located outside the main body and connected to the components inside the housing via electrical and/or mechanical means. The memory module stores software executable by one or more processors. The software may include a user navigation interface to help the user to use the machine and control software for controlling the machine's operations.

In one embodiment, the machine (100 or 300) includes an imaging system on a user-facing surface of the spray head, the viewing surface, etc. The imaging system uses depth-sensing technology to detect the depth and extrusions of the target area such as a user's face. The imaging system may include a number of cameras such as stereo cameras or other types of depth perception cameras, and may also include sensors such as frequency sensors (e.g., sensors that operate in the ultrasonic, infrared, low-frequency ultraviolet frequency range and/or another frequency range). Depth sensing enables the imaging system to create an accurate 3D mesh and accurately map the 3D mesh onto the target area. For example, when performing makeup on a user's face, an accurate 3D mesh allows the machine 100 or 300 to fit a 3D makeup design onto the face with precision. The imaging system may also include circuitry and/or software to detect depth using methods such as a contrast ratio method, a laser meter method, a focusing method, etc. The images captured by the imaging system can be used by the hardware and/or software in the machine 100 or 300 to locate the target area, create a 3D profile (e.g., a 3D mesh) of the user's face, and/or recognize the user's identity, among other functions. The imaging system may also include lights, which may include one or more of: light-emitting diode (LED) lights, diffused lights, etc., to illuminate the target area. The imaging system may also include one or more of: motion sensors, temperature sensors, light sensors, ultrasonic sensors, etc.

In one embodiment, the machine (100 or 300) includes an audio user interface such as a speaker. During operation, the machine may provide step-by-step audio commands through the speaker to guide the user. For example, the machine may generate audio commands through the speaker to remind the user to keep the eyes shut when makeup is being sprayed. The audio commands may also include suggestions, warnings, music, or other audio signals.

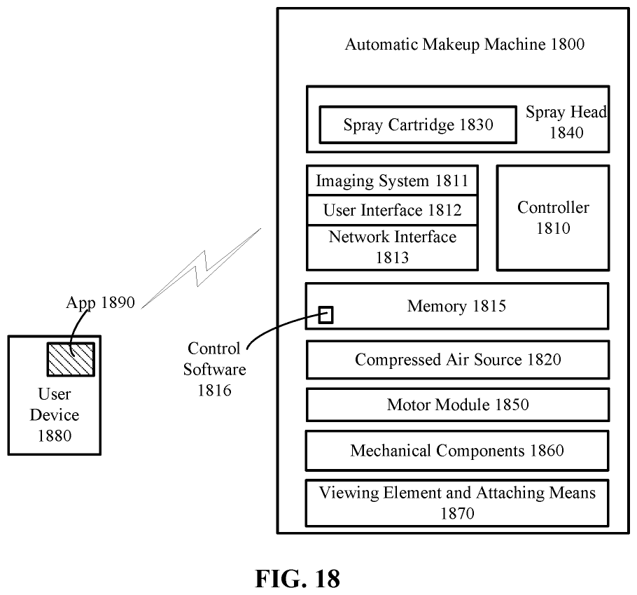

FIG. 18 is a block diagram illustrating an automatic makeup machine 1800 (“the machine 1800”) according to one embodiment. The machine 1800 may be an example of the aforementioned machine 100 and machine 300. It is understood the embodiment of FIG. 18 is simplified for illustration purposes. Additional hardware components may be included. The machine 1800 includes a spray head 1840 in which a spray cartridge 1830 may be installed and may be removed after use. In one embodiment, the spray cartridge 1830 may contain multiple liquid tanks and corresponding nozzles. In one embodiment, the spray cartridge 1830 may contain a single liquid tank and a single nozzle.

The machine 1800 includes a controller 1810, which may further include processing hardware such as one or more general-purpose processors, special-purpose circuits, or a combination of both. The controller 1810 is coupled to a memory 1815. The memory 1815 may include dynamic random access memory (DRAM), SRAM, flash memory, and other non-transitory machine-readable storage media; e.g., volatile or non-volatile memory devices. In one embodiment, the memory 1815 may store instructions which, when executed by the controller's processing hardware, cause the controller 1810 to control the automatic makeup operations and movements of the machine 1800, as well as the movements and spraying actions of the spray cartridge 1830. The controller 1810 may automatically control the air pump valve or air pump to output the air volume needed for optimal performance to control the flow of skin spray to the nozzle of the spray cartridge 1830.

The machine 1800 includes a motor module 1850, which further includes a number of motors. Under the control of the controller 1810, the motor module 1850 enables the movements of the spray head 1840 and the rotation of the spray cartridge 1830. Although FIG. 18 shows the motor module 1850 as a single block, it is understood that the motor module 1850 may include multiple motors located at multiple locations in the machine 1800 for controlling different movements of the spray head 1840 and the spray cartridge 1830. The machine 1800 further includes a compressed air source 1820 to supply compressed air to the spray cartridge 1830 under the command of the controller 1810. In some embodiments, the compressed air source 1820 may include more than one component such as an air tank inside the main body of the machine 1800 and an air compressor (i.e., air pump) outside the main body of the machine 1800. The compressed air source 1820 may be connected to other components of the machine 1800 via electrical wiring and air tubes. In some embodiments, the air pump and the machine housing may be placed on different surfaces; e.g., the machine main body on a tabletop and the air pump on the floor. Placing the air pump outside the machine's main body may reduce vibration and noise, which are not only unpleasant to the user but also decrease the accuracy of spraying operations. The machine 1800 further includes mechanical components 1860 such as robotic components to move the spray head 1840 under the command of the controller 1810. In one embodiment, the machine 1800 further includes a viewing element and attaching means 1870; a non-limiting example is the viewing element 170 (FIGS. 1) and 370 (FIG. 10).

The controller 1810 executes control software 1816 stored in the memory 1815 to control the makeup process including the determination and customization of machine movements. In one embodiment, the machine 1800 further includes an imaging system 1811 to capture a 3D profile of the target area, such as a user's 3D facial image. According to the 3D profile, the controller 1810 can execute the control software 1816 to determine a sequence of positions and orientations of the spray head 1840 to apply or spray liquids from the spray cartridge 1830. The controller 1810 then instructs the motor module 1850 to move the spray head 1840 according to the sequence of positions and orientations. The imaging system 1811 can also be used to monitor the liquid application process (e.g., a makeup process). The controller 1810 may use the information from the cameras to ensure the safety and proper usage of the machine 1800. In one embodiment, the spray cartridge 1830 or the spray head 1840 may be marked with a number of fiduciary markings. One or more rear-facing cameras may be installed on the part of the machine 1800 that faces the spray head 1840, such that during an application session the rear-facing cameras can continuously monitor the locations and orientations of the spray cartridge 1830 based on the fiduciary markings. One or more user-facing cameras may monitor the location and orientation of the user's face. From the monitored data, the controller 1810 can determine the distance and angle between the spray cartridge 1830 and the user's face to further determine whether it is safe to apply makeup to the face.

In one embodiment, the machine 1800 may include a user interface 1812 such as a graphical user interface (GUI), through which the controller 1810 can communicate with the user; e.g., regarding the makeup process and color options, and guide the user through the makeup process. In one embodiment, the machine 1800 may also include a network interface 1813 to connect to a wired and/or wireless network for transmitting and/or receiving voice, digital data, and/or media signals. For example, the machine 1800 may communicate with a user device 1880 via the network interface 1813. The user device 1880 may run a user app 1890 for the user to communicate with the machine 1800. In one embodiment, the machine 1800 can be controlled remotely via the network interface 1813 by another device, which may be the user device 1880 or a remote control device.

Embodiments of a makeup machine have been described. In one embodiment, an apparatus such as a makeup machine includes a spray head having a receptacle to receive a spray cartridge containing a skin spray; a main body to house a controller circuit that controls a position of the spray head with respect to a target of the skin spray; an arched track having a curved shape on a horizontal plane; and a vertical support attached to the arched track. The controller circuit causes the spray head to slide along the arched track, and adjusts a height of the vertical support to cause the arched track and the spray head to move up and down.

In one embodiment, the vertical support includes at least two vertical pillars attached to both a right side and a left side of the arched track. In one embodiment, the vertical support includes at least two vertical pillars housed inside side arms of the machine, and the side arms are stationary during operation of the machine. In another embodiment, the vertical support includes one or more vertical pillars extending upwards from an arched base, where the arched base and the arched track are movable in tandem in a proximal-distal direction with respect to the target of the skin spray.

In one embodiment, the controller circuit causes the spray head to slide along a linear track in a radial direction of the arched track, and causes the linear track to slide with the spray head along the arched track. In one embodiment, the linear track lies on top of a track connector, and the track connector is used to attach the spray head to the arched track. In another embodiment, the apparatus further includes an arched base coupled to a bottom of the arched track, and a linear track attached to the arched base. The linear track may extend and retract on the horizontal plane to cause the arched base and the arched track to move in a proximal-distal direction with respect to the target of the skin spray. The linear track may stay on a horizontal centerline when the spray head slides along the arched track. The linear track may have a horizontal length adjustable by the controller circuit to position the spray head at a given horizontal distance from the target.

In one embodiment, the controller circuit is operable to adjust a spray angle from a nozzle of the spray cartridge by horizontally rotating the spray cartridge within a predetermined angular range. The controller circuit may be operable to cause the spray cartridge to rotate horizontally to aim a selected one of a plurality of nozzles at the target.

In one embodiment, the spray head includes a front opening that exposes a front portion and a bottom portion of the spray cartridge. In one embodiment, the spray cartridge lies horizontally in the spray head and is horizontally rotatable.

In one embodiment, the apparatus further includes a viewing surface attached to a foldable stand secured to a back side of the main body. The foldable stand in a deployed position may cause the viewing surface to face the target, and in a stowed position may cause the viewing surface to face a top of the main body.

In one embodiment, the apparatus further includes a chin support assembly having an elongated shape in the vertical direction, a top portion of the chin support assembly attached to a front section of the main body to provide support to a user's chin. The chin support assembly may include a removable support pad on top and a removable cover in front. The chin support may further include one or both of a pressure sensor and a proximity sensor. In another embodiment, the chin support may further include a front piece and a back piece, the front piece being up-and-down adjustable to provide support to a user's chin.

In another embodiment, an apparatus such as a makeup machine includes a spray head, a main body, an arched track, at least one vertical support, and a linear track. The spray head has a receptacle to receive a spray cartridge that contains a skin spray. The main body houses a controller circuit that controls a position of the spray head with respect to a target of the skin spray. At least a portion of the main body is located between an arched track and the target. The arched track has a curved shape on a horizontal plane. The controller circuit causes the spray head to slide along the arched track. The at least one vertical support has an adjustable height and is attached to both the right side and the left side of the arched track. The linear track is controlled by the controller circuit to adjust a horizontal distance between the spray head and the target.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuity in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. An apparatus comprising:
a spray head having a receptacle to receive a spray cartridge containing a skin spray;
a main body to house a controller circuit that controls a position of the spray head with respect to a target of the skin spray;
an arched track having a curved shape on a horizontal plane, wherein the controller circuit causes the spray head to slide along the arched track; and
a vertical support attached to the arched track, wherein the controller circuit adjusts a height of the vertical support to cause the arched track and the spray head to move up and down.

2. The apparatus of claim 1, wherein the spray cartridge lies horizontally in the spray head and is horizontally rotatable.

3. The apparatus of claim 1, wherein the vertical support includes at least two vertical pillars housed inside side arms of the machine, and wherein the side arms are stationary during operation of the machine.

4. The apparatus of claim 1, wherein the vertical support includes at least two vertical pillars attached to both a right side and a left side of the arched track.

5. The apparatus of claim 1, wherein the controller circuit causes the spray head to slide along a linear track in a radial direction of the arched track, and causes the linear track to slide with the spray head along the arched track.

6. The apparatus of claim 5, wherein the linear track lies on top of a track connector, and the track connector is used to attach the spray head to the arched track.

7. The apparatus of claim 1, wherein the vertical support includes one or more vertical pillars extending upwards from an arched base, and wherein the arched base and the arched track are movable in tandem in a proximal-distal direction with respect to the target of the skin spray.

8. The apparatus of claim 1, further comprising:
an arched base coupled to a bottom of the arched track; and
a linear track attached to the arched base, wherein the linear track extends and retracts on the horizontal plane to cause the arched base and the arched track to move in a proximal-distal direction with respect to the target of the skin spray.

9. The apparatus of claim 1, wherein the linear track stays on a horizontal centerline when the spray head slides along the arched track, the linear track having a horizontal length adjustable by the controller circuit to position the spray head at a given horizontal distance from the target.

10. The apparatus of claim 1, wherein the controller circuit is operable to adjust a spray angle from a nozzle of the spray cartridge by horizontally rotating the spray cartridge within a predetermined angular range.

11. The apparatus of claim 1, wherein the controller circuit is operable to cause the spray cartridge to rotate horizontally to aim a selected one of a plurality of nozzles at the target.

12. The apparatus of claim 1, wherein the spray head includes a front opening that exposes a front portion and a bottom portion of the spray cartridge.

13. The apparatus of claim 1, further comprising:
a viewing surface attached to a foldable stand secured to a back side of the main body, wherein the foldable stand in a deployed position causes the viewing surface to face the target, and in a stowed position causes the viewing surface to face a top of the main body.

14. The apparatus of claim 1, further comprising:
a chin support assembly having an elongated shape in the vertical direction, a top portion of the chin support assembly attached to a front section of the main body to provide support to a user's chin.

15. The apparatus of claim 14, wherein the chin support assembly includes a removable support pad on top and a removable cover in front.

16. The apparatus of claim 1, further comprising:
a chin support that further includes one or both of a pressure sensor and a proximity sensor.

17. The apparatus of claim 1, further comprising:
a chin support that further includes a front piece and a back piece, the front piece being up-and-down adjustable to provide support to a user's chin.

18. An apparatus comprising:
a spray head having a receptacle to receive a spray cartridge that contains a skin spray;
a main body to house a controller circuit that controls a position of the spray head with respect to a target of the skin spray, wherein at least a portion of the main body is located between an arched track and the target;
the arched track having a curved shape on a horizontal plane, wherein the controller circuit causes the spray head to slide along the arched track;
at least one vertical support having an adjustable height and attached to both a right side and a left side of the arched track; and
a linear track controlled by the controller circuit to adjust a horizontal distance between the spray head and the target.

19. The apparatus of claim 18, wherein the linear track moves with the spray head along the arched track, the spray head is movable forwards and backward on the linear track at any given location on the arched track.

20. The apparatus of claim 18, wherein the linear track stays on a horizontal centerline and has a horizontal length adjustable by the controller circuit to position the spray head at a given horizontal distance from the target.
